(19) United States
(12) Patent Application Publication
(10) Pub. No.: US 2008/0022934 A1
(43) Pub. Date: Jan. 31, 2008

(54) Covered Pet Bed

(76) Inventor: Deborah Ann Kruczek, Pembroke Pine, FL (US)

Correspondence Address: Deborah Ann Kruczek, 13242 NW 8th Street, Pembroke Pines, FL, 33028, US

(21) Appl. No.: 11/459,758

(22) Filed: Jul. 25, 2006

(51) Int. Cl. A01K 29/00

(52) U.S. Cl. 119/28.5

(57) ABSTRACT

A covered pet bed comprising an extended padded bottom covered in a soft reversible fabric with a permanently attached cover member that is fronted by a self-formed tube filled with batting which keeps the cover member lifted and allows access under the cover member by the pet. The padded bottom extends out past the cover member and has a permanently attached pillow. The pillow is shaped to compliment the pet for which the covered pet bed is intended, and the pillow may be embroidered with the pet's name. The covered pet bed is reversible and fully machine washable and dryable.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

This invention provides small pets and their owners with a covered pet bed that has a combination of unique features. This invention came about at the request of my daughter, who has three small dogs and observed that no where on the market has she been able to find a pet bed that embodies all the following elements: a covered pet bed in which the cover member stays up, with an extended padded bottom, defining an opening that allows easy access by the pet; a covered pet bed that has an incorporated pillow on which the pet may rest its head and be customized by embroidering the pet's name; and a covered pet bed that is reversible for extended wear and is fully machine washable and dryable.

### DESCRIPTION OF PRIOR ART

White the prior art listed below are useful for pets as various sleeping quarters, none have embodied the comfort, simplicity, attractiveness, customization options, and ease of maintenance as the present invention.

U.S. Patent Documents

| D377545 | April, 1996 | Iben |
|---|---|---|
| D377852 | April, 1996 | Iben |
| 3989008 | November, 1976 | Neumann |
| 4008687 | February, 1977 | Keys |
| 4169428 | October, 1979 | Waugh |
| 4893586 | January, 1990 | Carson |
| 5000116 | March, 1991 | Fife |
| 5010843 | April, 1991 | Henry |
| 5327851 | July, 1994 | Pare et. Al. |
| 5357901 | October, 1994 | Batts |
| 5749314 | May, 1998 | Pelham, et. al. |
| 6378456 | April, 2002 | Jerome |

The Covered Pet Bed in U.S. Pat. D377,545. the Covered Pet Bed in U.S. Pat. D377,852 the Dog Bed in U.S. Pat. No. 3,989,008, and the Self-Covering Pet Bed in U.S. Pat. No. 5,000,116, show beds with similar functions, but all are complex in their design and do not afford the ease of maintenance and reversible feature as does the present invention.

The Sleeping Nook for House Pet in U.S. Pat. No. 4,008,687, the Pet Sleeping Bag in U.S. Pat. No. 4,169,428, the Sleeping Bag for Pets in U.S. Pat. No. 4,893,586, the Animal Sleeping Bag in U.S. Pat. No. 5,327,851, and the Sleeping Bag for Pets in U.S. Pat. No. 6,378,456 also serve to keep the pet covered, but do not offer the pet the same level of access and do not offer the same ease of maintenance and reversibility.

The Pet Bed in U.S. Pat. No. 5,010,843 also provides a similar function, but once again is complex in design, is difficult to disassemble for cleaning, and is not reversible.

The Pet Comforter in U.S. Pat. No. 5,357,901 also serves a similar function, but its cover does not have the same stability as the present invention.

The Covered Dog Bed in U.S. Pat. No. 5,749,314 also keeps the pet covered, but it does not have an extended base to further define the bed opening, does not provide the pet with a pillow, is not reversible and uses a semi-rigid member to define the doorway.

### BRIEF SUMMARY OF THE INVENTION

The present invention is to provide a covered pet bed with a defined opening made of a soft reversible fabric and filled with high loft batting that will appeal to the pet's natural tendency to burrow. The present invention provides the pet with a pillow on which to rest its head and provides the pet's owner with the option of personalizing the bed. The present invention is also reversible and machine washable and dryable. The present invention addresses the limitations of other pet beds as listed in the prior art. The suggested dimensions of the covered pet bed depend on the type and size of the animal. The width of the cover member will be greater than the width of the padded base to create the burrow area for the pet. A small covered pet bed may have a finished size of approximately 12 inches wide by 18 inches long and its matching cover member may have a finished dimension of 21 inches wide by 15 inches long, allowing the padded base to extend beyond the cover member by approximately three inches at its center point. Although the description above contains much specificity. the invention in its broader aspects is not limited to a specific size. and departures may be made from such details without departing from the principles of the invention and without sacrificing its primary advantages.

### OBJECTS OF THE INVENTION

(a) To provide an improved covered pet bed;
(b) To provide a covered pet bed that is easy for the pet to use by creating an improved defined opening;
(c) To provide a sleeping area where the pet may borough under the cover;
(d) To provide a covered pet bed that has an integrated pillow on which the pet may rest its head;
(e) To provide a covered pet bed that may be customized by embroidering the pet's name on the pillow;
(f) To provide a covered pet bed that is simple to manufacture;
(g) To provide a covered pet bed that requires no assembly or disassembly;
(h) To provide a covered pet bed that is reversible and 100% washable and dryable.

### BRIEF DESCRIPTION OF THE SEVERAL VIEWS OF THE DRAWING

FIG. 1 is a top view of the covered pet bed in accordance with the invention;

FIG. 2 is a front view of the covered pet bed;

FIG. 3 is a side view of the covered pet bed;

FIG. 4 is a view of the components of padded bottom 20;

FIG. 5 is a fragmentary cross sectional view of padded bottom 20;

FIG. 6 is a top view of cover member 40;

FIG. 7 is a fragmentary cross-sectional view of cover member 40 and tube 46;

FIG. 8 is a top view of the components of pillow 60;

FIG. 9 is a fragmentary cross-sectional view of pillow 60.

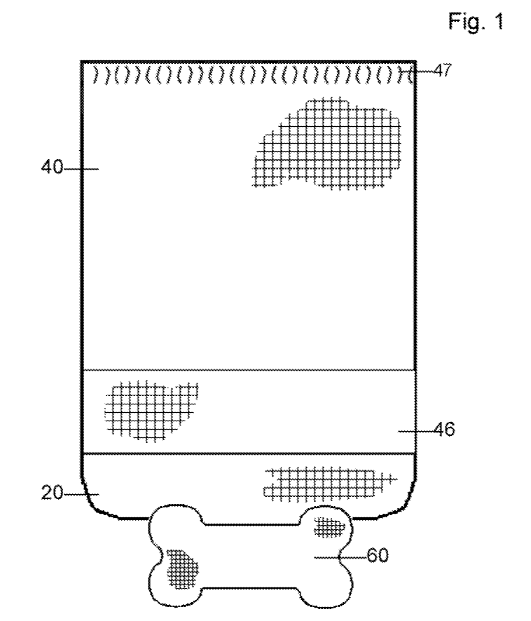

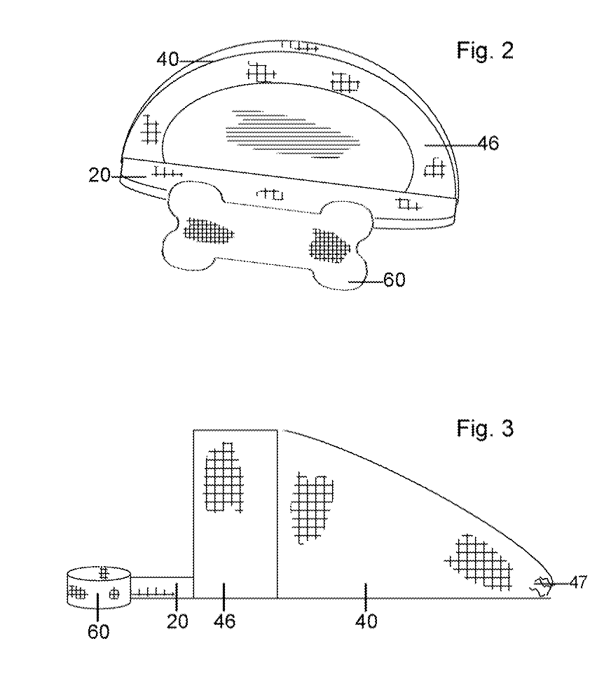

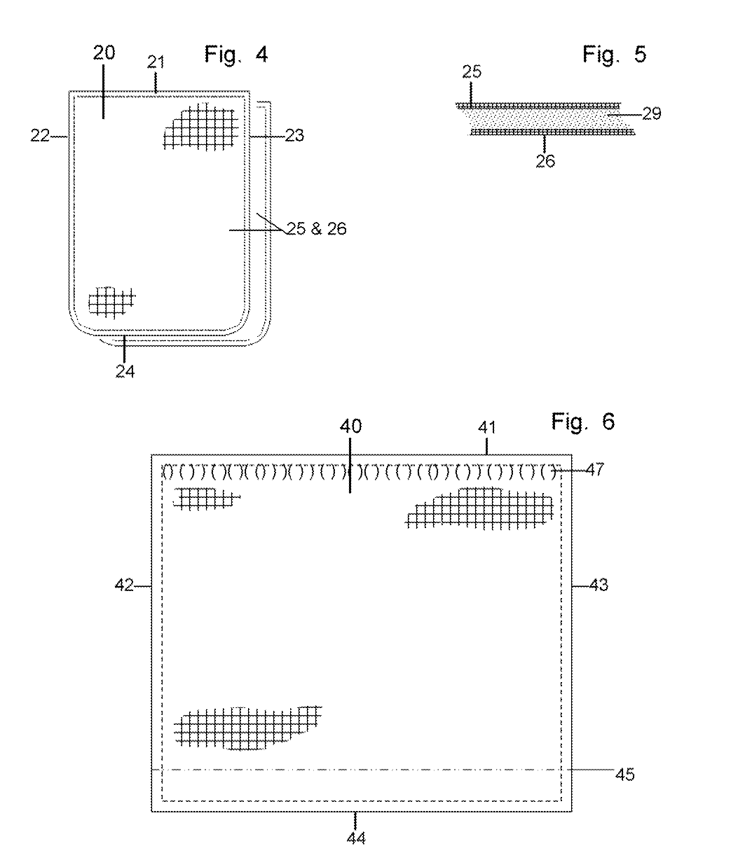

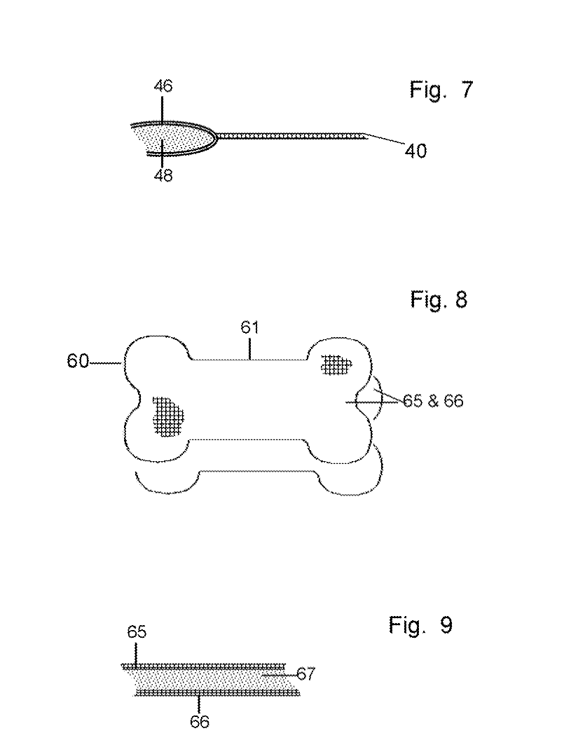

### REFERENCE NUMERALS IN THE DRAWING

20 padded bottom
21 back edge of fabric members 25/26
22 side edge of fabric members 25/26
23 side edge of fabric members 25/26
24 front edge of fabric members 25/26
25 and 26 fabric members for padded bottom 20
29 batting for padded bottom 20
40 cover member
41 back edge of cover member 40
42 side edge of fabric member 40
43 side edge of fabric member 40
44 front edge of fabric member 40
45 fold line for tube 46
46 tube
47 gathers
48 batting for tube 46
60 pillow
65 fabric member for pillow 60
66 fabric member for pillow 60
67 batting for pillow 60

### DETAILED DESCRIPTION OF THE INVENTION

A covered pet bed in accordance with the invention that includes a padded bottom 20 and a cover member 40. Padded bottom 20 is comprised of two equal cuts of a soft reversible fabric, such as velour fleece, members 25 and 26, and batting 29. Padded bottom 20 is rectangular in shape with a squared back and with front rounded corners. Its dimensions are such that when assembled, the padded base will extend out past cover member 40. A minimum of two layers of high loft batting 29 are used for the filling.

Cover member 40 is a single piece of soft reversible fabric, and is rectangular in shape. Several inches of cover member 40 are folded over and stitched in place to form tube 46.

To begin assembly, cover member 40 is gathered 47 along edge 41 equal to the width of edge 21 of fabric members 25/26. Next edge 44 of cover member 40 is folded over approximately 4.5 inches along fold line 45 and stitched in place to form tube 46. Next cover member 40 is stitched to fabric member 25, right sides facing. Side edge 42 is stitched to side edge 23 leaving the end of tube 46 open. Side edge 43 is stitched to side edge 22 leaving the other end of tube 46 open. Then fabric member 25 is attached to fabric member 26, right sides facing, along the same stitching lines used to attach cover member 40 to fabric member 25, leaving an opening on edges 21/41 large enough to turn the bed right side out. Next, a minimum of two layers of high loft batting 29 are attached to the wrong side of fabric member 26.

Then the covered pet bed is turned right side out, and a piece of high loft batting 48 measuring approximately 12.5 inches long and equal to the width of cover member 40 is folded in thirds and inserted through tube 46. Next the bed is turned right side in, and both ends of tube 46 are stitched shut. Then the bed is once again turned right side out, and the remaining opening of back edges 21/41 is hand-stitched shut.

Next, a pillow comprised of fabric members 65 and 66 and batting 67 is created. The pillow may be cut in the shape of a bone for a dog or in the shape of a fish for a cat or other such shapes so as to compliment the pet for which the specific covered pet bed is intended. After the shape of the pillow is cut from fabric members 65/66, the pillow may be embroidered with the pet's name, if desired. Next fabric members 65 and 66 are stitched together right sides facing. Two layers of high loft batting 67 are attached to the wrong side of fabric member 65, leaving an opening in the center of side 61 large enough to right side out the pillow. Next the pillow is turned right side out and, if additional plumping of the pillow is desired, additional batting may be inserted into the center of the pillow between the two layers of batting 67. Next the opening on side 61 is stitched shut. The final step is to center the pillow along the front edge of padded bottom 20 and hand-stitch pillow 60 in place.

I claim:

1. A covered bed for pets comprised of:
(a) An extended padded bottom consisting of two pieces of a soft. reversible fabric with layers of high loft batting in the middle;
(b) A cover member composed of a soft reversible fabric that is attached to the padded bottom on both of its sides and along its back. Said cover member is gathered along its back edge to allow for expansion and comfortable access by the pet. This cover member will have a self-forming tube, achieved by folding over the front edge of the cover member several inches and stitching it in place to form the tube. Said tube is filled with high loft batting to create the defined opening of the covered pet bed.
(c) The covered pet bed will have a pillow permanently attached to the center portion of the front edge of the padded bottom, said pillow being of assorted shapes to complement the pet for which it will be used. The pillow will have the option of being customized by embroidering it with the pet's name.
(d) The covered pet bed is reversible and fully machine washable and dryable.
